(19) United States
(12) Patent Application Publication
(10) Pub. No.: US 2013/0133443 A1
(43) Pub. Date: May 30, 2013

(54) TESTING APPARATUS FOR EXPANSION CARD

(71) Applicants: WEI-MIN QIN, Wuhan City (CN); WEI LIANG, Wuhan City (CN); YU-LIN LIU, Wuhan City (CN)

(72) Inventors: WEI-MIN QIN, Wuhan City (CN); WEI LIANG, Wuhan City (CN); YU-LIN LIU, Wuhan City (CN)

(73) Assignees: HON HAI PRECISION INDUSTRY CO., LTD., Tu-Cheng (TW); HONG FU JIN PRECISION INDUSTRY (WUHAN) CO., LTD., Wuhan City (CN)

(21) Appl. No.: 13/472,453

(22) Filed: May 15, 2012

(30) Foreign Application Priority Data
Nov. 24, 2011 (CN) 201110378237.X

(51) Int. Cl. G01N 37/00

(52) U.S. Cl. 73/864.91

(57) ABSTRACT

A testing apparatus includes a testing desk; a supporting tray adapted for securing an expansion card, and a lifting device attached to the testing desk. The supporting tray includes a retaining portion rotatably attached to the testing desk. The lifting device includes a positioning post and a lifting post moveably received in the positioning post. The supporting tray is slanted relative to the testing desk, the lifting post is rotatable relative to the positioning post in a direction substantially perpendicular to the testing desk, and the supporting tray is rotatable relative to the testing desk for adjusting an angle between the supporting tray and the testing desk.

### BACKGROUND

1. Technical Field

The present disclosure relates to a testing apparatus for an expansion card.

2. Description of Related Art

Expansion cards includes a plurality of conditions that need to be tested, and different testing conditions need a different testing angles. When the expansion card being tested, the expansion card is sandwiched between a mounting clamp and a supporting mechanism, which is inconvenient to adjust the testing angle.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a testing apparatus and an expansion card in accordance with an embodiment.

FIG. 2 is an assembled view of FIG. 1.

FIG. 3 is a side view of FIG. 2.

FIG. 4 is similar to FIG. 3, but viewed in a different aspect.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

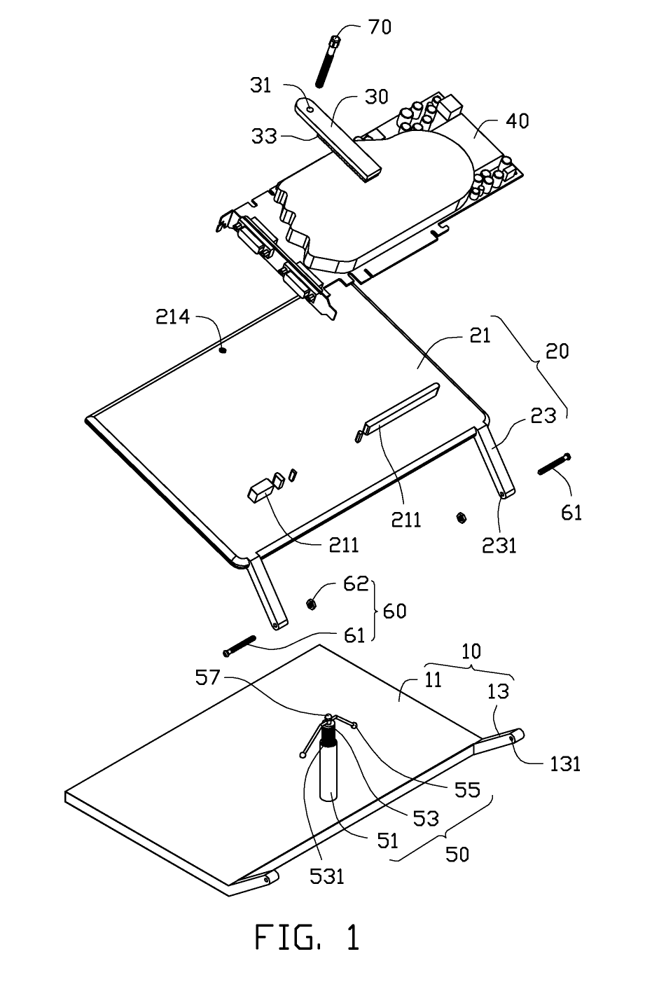

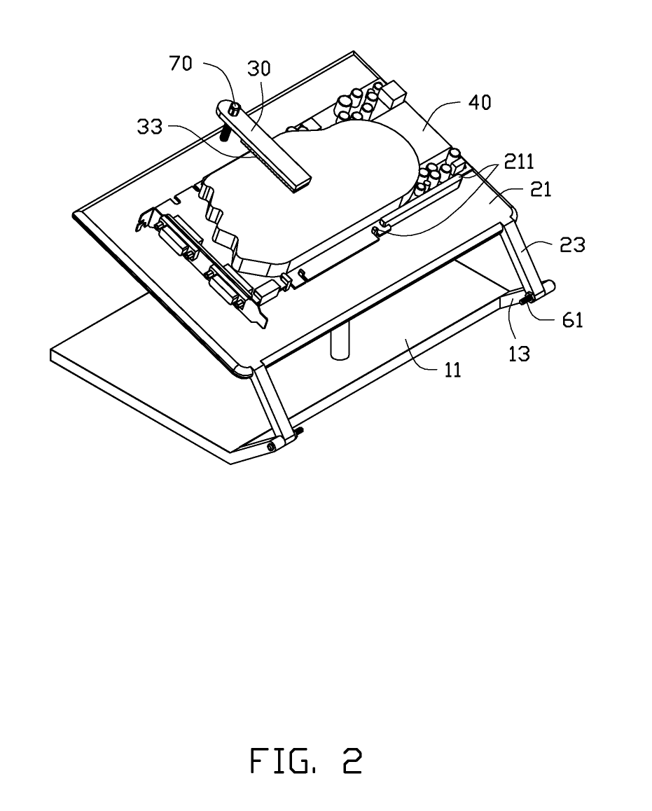

Referring to FIGS. 1 and 2, a testing apparatus in accordance with an embodiment includes a testing desk 10, a supporting tray 20 rotatably attached to the testing desk 10, and a clamp 30 attached to the supporting tray 20. The testing apparatus is used to test an expansion card 40. In one embodiment, the expansion card 40 may be, for example, sound cards, video cards, graphics cards, or other Peripheral Component Interconnection (PCI) cards.

The testing desk 10 includes a base 11 and two securing portions 13 extending from an edge of the base 11. Each of the two securing portion 13 defines a securing hole 131. The base 11 is rectangular shaped. Each of the two securing portions 13 is slanted relative to the base 11, and an obtuse angle is defined between the base 11 and each of the two securing portions 13. A lifting device 50 is secured to the base 11. The lifting device 50 includes a positioning post 51, a lifting post 53 received in the positioning post 51, and two operating poles 55 attached to the lifting post 53. An inner screw thread (not shown) is defined in an inner surface of the positioning post 51. An outer screw thread 531 corresponding to the inner screw thread is defined in the lifting post 53. The outer screw thread 531 is engaged with the inner screw thread, to move the lifting post 53 up and down relative to the positioning post 51 in a direction substantially perpendicular to the base 11. A driving portion 57 is attached to the lifting post 53 and located between the two operating poles 55. In one embodiment, the driving portion 57 is a ball bearing.

The supporting tray 20 includes a supporting panel 21 and two retaining portions 23 extending from an edge of the supporting panel 21. The supporting panel 21 can be rectangular in shape. Each of the two retaining portions 23 is slanted relative to the supporting panel 21, and an obtuse angle is defined between the supporting panel 21 and each of the retaining portions 23. A plurality of positioning blocks 211 are attached to the supporting panel 21. In one embodiment, a size of each of the plurality of positioning blocks 211, or an arrangement of the plurality of positioning block 211 can be adjusted according to a size or an arrangement of the expansion card 40, so that the expansion card 40 can be stably secured to the supporting panel 21 by the plurality of positioning block 211. A fixing hole 214 is defined in the supporting panel 21 away from the retaining portions 23. A retaining hole 231, corresponding to the securing hole 131, is defined in each of the two retaining portions 23.

The clamp 30 defines a mounting hole 31, corresponding to the fixing hole 214. A gasket 33 is attached to the clamp 30 for preventing the clamp 30 from abutting the expansion card 40. In one embodiment, the gasket 33 is a plastic and is directed towards expansion card 40.

Referring to FIG. 2, in assembly, the supporting tray 20 is above the testing desk 10. Each of the two retaining holes 231 are aligned with each of the two securing holes 131. A stud 61 of a mounting member 60 is engaged in each of the two retaining holes 231 and each of the two securing holes 131, and a nut 62 of the mounting member 60 is engaged with the stud 61. Thus, the two retaining portions 23 are rotatably secured to the two securing portions 13.

The clamp 30 is above the supporting tray 20, and the mounting hole 31 is aligned with the fixing hole 214. A fixing member 70 is engaged in the mounting hole 31 and the fixing hole 214, to moveably secure the clamp 30 to the supporting panel 21.

When the expansion card 40 needs to be tested, the fixing member 70 is adjusted. The clamp 30 is moved away from the supporting panel 21, and the expansion card 40 is located between the clamp 30 and the supporting panel 21. The clamp 30 is moved towards the supporting panel 21, and the clamp 30 is pressed on the expansion card 40. Therefore, the expansion card 40 is steady nipped between the supporting panel 21 and the clamp 30, to be tested.

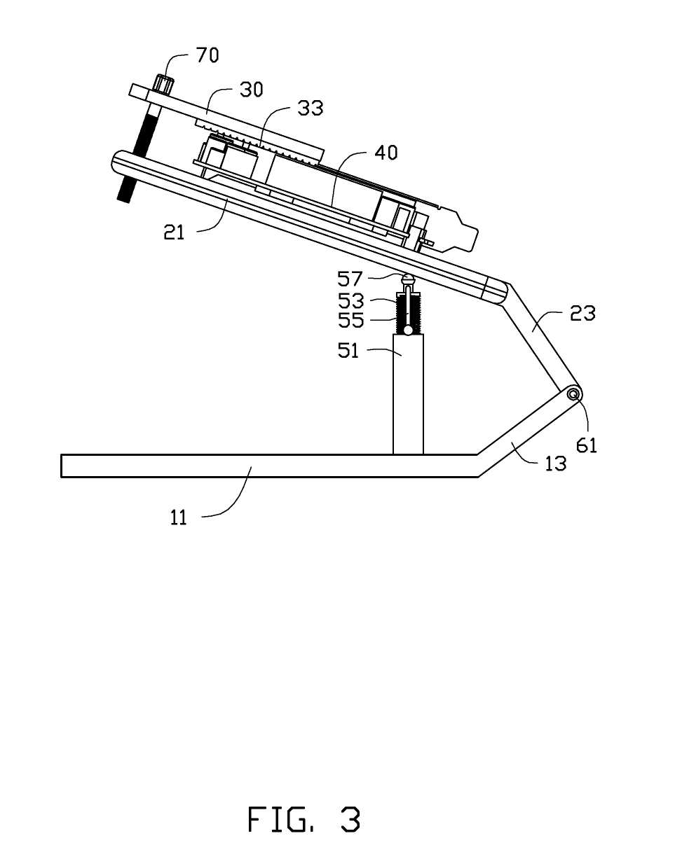

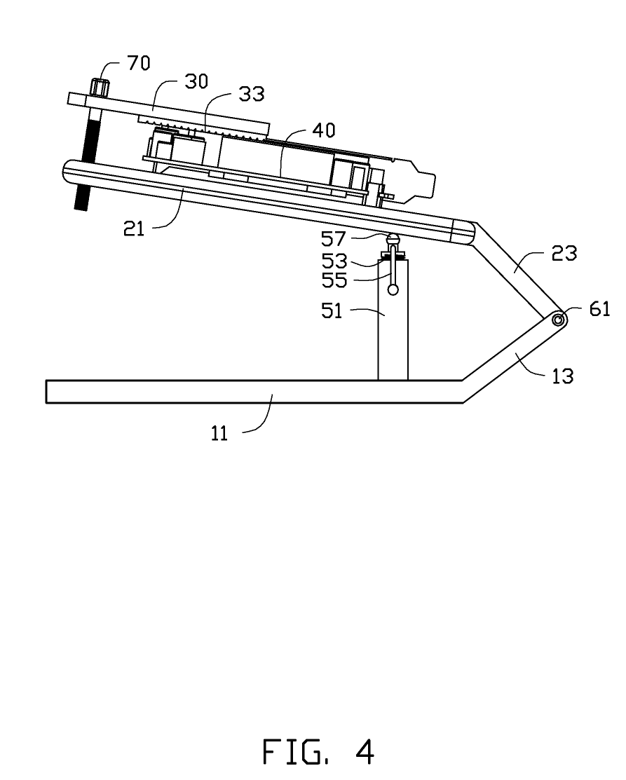

Referring to FIGS. 3-4, when the expansion card 40 need to be moved upward, the two operating poles 55 are operated in the counterclockwise direction, an the lifting post 53 is moved upward relative to the base 11 in a first direction substantially perpendicular to the base 11. The driving portion 57 is rotated to move the supporting panel 21 upward, and each of the two retaining portions 23 is rotated about the stud 61, relative to each of the two securing portions 13, until the expansion card 40 is moved to a predetermined angle.

When the expansion card 40 need to be moved downward, the two operating poles 55 are operated in the clockwise direction, and the lifting post 53 is moved downward relative to the base 11 in the first direction. The driving portion 57 is rotated to move the supporting panel 21 downward, and each of the two retaining portions 23 is rotated about the stud 61 relative to each of the two securing portions 13, until the expansion card 40 is moved to a predetermined angle.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A testing apparatus comprising:
a testing desk;
a supporting tray comprising a retaining portion rotatably attached to the testing desk; and
a lifting device, attached to the testing desk, comprising a positioning post and a lifting post moveably received in the positioning post;
wherein the supporting tray is slanted relative to the testing desk, the lifting post is moveable relative to the positioning post in a direction substantially perpendicular to the testing desk, and the supporting tray is rotatable relative to the testing desk for adjusting an angle between the supporting tray and the testing desk.

2. The testing apparatus of claim 1, wherein the lifting device further comprises a driving portion attached to the lifting post, and the driving portion abuts the supporting tray.

3. The testing apparatus of claim 2, wherein the driving portion is a ball bearing.

4. The testing apparatus of claim 1, further comprising a clamp attached to the supporting tray, and the clamp is moveable relative to the supporting tray, for sandwiching an expansion card between the clamp and the supporting tray.

5. The testing apparatus of claim 4, wherein a gasket is attached to the clamp, and the gasket prevents the clamp from abutting the expansion card.

6. The testing apparatus of claim 1, wherein the supporting tray further comprises a supporting panel, and the retaining portion is slanted relative to the supporting panel.

7. The testing apparatus of claim 6, further comprising a plurality of positioning blocks, and the plurality of positioning blocks are located on the supporting panel.

8. The testing apparatus of claim 6, wherein the testing desk further comprises a securing portion, a mounting member is engaged with the securing portion and the mounting portion, and the mounting portion is secured to the securing portion and rotatable about the mounting member relative to the securing portion.

9. The testing apparatus of claim 8, wherein the testing desk further comprises a base, the securing portion is slanted relative to the testing desk, and an obtuse angle is defined between the base and the securing portion.

10. The testing apparatus of claim 1, wherein an outer screw thread is defined in the lifting post, and an inner screw thread is defined in the positioning post to engage with the outer screw thread.

11. A testing apparatus comprising:
a testing desk comprising a base and a securing portion extending from the base; the securing portion being slanted relative to the base;
a supporting tray comprising a supporting panel and a retaining portion extending from the supporting panel; the retaining portion rotatably attached to the securing portion; and
a lifting device, attached to the base, comprising a positioning post and a lifting post moveably received in the positioning post;
wherein the lifting post is rotatable about a first axis and moveable relative to the positioning post in a direction that is substantially perpendicular to the testing desk, and the retaining portion is rotatable about a second axis that is substantially perpendicular to the first axis to move the supporting tray, for adjusting an angle between the supporting tray and the testing desk.

12. The testing apparatus of claim 11, wherein the lifting device further comprises a driving portion attached to the lifting post, and the driving portion abuts the supporting tray.

13. The testing apparatus of claim 12, wherein the driving portion is a ball bearing.

14. The testing apparatus of claim 11, further comprising a clamp attached to the supporting tray, and the clamp is moveable relative to the supporting tray, for sandwiching an expansion card between the clamp and the supporting tray.

15. The testing apparatus of claim 14, wherein a gasket is attached to the clamp, and the gasket prevents the clamp from abutting the expansion card.

16. The testing apparatus of claim 11, wherein an obtuse angle is defined between the securing portion and the base.

17. The testing apparatus of claim 11, further comprising a plurality of positioning blocks, and the plurality of positioning blocks located on the supporting panel.

18. The testing apparatus of claim 11, wherein an obtuse angle is defined between the supporting panel and the retaining portion.

19. The testing apparatus of claim 11, wherein an outer screw thread is defined in the lifting post, and an inner screw thread is defined in the positioning post to engage with the outer screw thread.
